(19) United States
(12) Patent Application Publication
(10) Pub. No.: US 2025/0103974 A1
(43) Pub. Date: Mar. 27, 2025

(54) TASK CONTENT IDENTIFYING SYSTEM, TASK CONTENT IDENTIFYING METHOD, AND STORAGE MEDIUM

(71) Applicant: TOYOTA JIDOSHA KABUSHIKI KAISHA, Toyota-shi (JP)

(72) Inventors: Tomohiro MATSUDA, Toyota-shi (JP); Yuta TSUBAKI, Toyota-shi (JP); Akira NUMASATO, Nagakute-shi (JP); Tomohiro TSUBOTA, Nagoya-shi (JP)

(73) Assignee: TOYOTA JIDOSHA KABUSHIKI KAISHA, Toyota-shi (JP)

(21) Appl. No.: 18/891,210

(22) Filed: Sep. 20, 2024

(30) Foreign Application Priority Data
Sep. 27, 2023 (JP) 2023-166167

(51) Int. Cl. G06Q 10/0631

(52) U.S. Cl. CPC G06Q 10/063112

(57) ABSTRACT

In a series of tasks consisting of a plurality of consecutive element tasks, a task content identifying system for identifying task contents performed by a worker includes: an information acquisition unit that acquires sensor information indicating a state of a worker when the worker performs the element task; a storage unit that stores a determination model of each element task for identifying each element task; a task identifying unit that specifies an element task performed by the worker by comparing the sensor information of the worker acquired by the information acquisition unit with a determination model of each element task stored by the storage unit; and a priority setting unit that sets a priority of the determination model of each element task when the task identifying unit performs a comparison.

### CROSS-REFERENCE TO RELATED APPLICATION

This application claims priority to Japanese Patent Application No. 2023-166167 filed on Sep. 27, 2023. The disclosure of the above-identified application, including the specification, drawings, and claims, is incorporated by reference herein in its entirety.

### BACKGROUND

### 1. Technical Field

The present disclosure relates to a task content identifying system, a task content identifying method, and a storage medium, for identifying a task content.

### 2. Description of Related Art

A system for identifying a task content of a worker based on sensor information of the worker or the like is known (e.g., see Japanese Unexamined Patent Application Publication No. 2019-41811 (JP 2019-41811 A)).

### SUMMARY

For example, sensor information of the worker is compared with a determination model for each task, thereby identifying the task content performed by the worker. At this time, when the sensor information of the worker and the determination model for each task are compared in random order, waste of calculation occurs, and efficiency is not good.

The present disclosure has been made to solve such problems, and a primary object thereof is to provide a task content identifying system, a task content identifying method, and a storage medium, that can efficiently identify task content of a worker.

An aspect of the present disclosure for achieving the above object is a task content identifying system for identifying a task content performed by a worker in a series of tasks made up of a plurality of element tasks that is consecutive, the task content identifying system including
an information acquisition unit that acquires sensor information indicating a state of the worker when the worker performs the element tasks,
a storage unit that stores each of determination models for each of the element tasks, for identifying each of the element tasks,
a task identifying unit that identifies the element task that the worker is performing, by comparing the sensor information of the worker acquired by the information acquisition unit with the determination models for each of the element tasks stored in the storage unit, and
a priority setting unit that sets a priority of the determination model for each of the element tasks for when the task identifying unit performs the comparison.

In this aspect, the task identifying unit may compare the sensor information of the worker acquired by the information acquisition unit with the sensor information of the worker, in order from the determination model of the element task to which a high priority is set by the priority setting unit, and when the determination model of the element task matches the sensor information of the worker, identify the element task of the determination model that matched as being the task content being performed by the worker.

In this aspect, in the series of tasks, a probability value of each of the element tasks to be performed subsequent to each of the element tasks may be set in advance, and the priority setting unit may set the priority of the determination model of the element task of which the probability value is high, to be high.

An aspect of the present disclosure for achieving the above object is
a task content identifying method of identifying a task content performed by a worker in a series of tasks made up of a plurality of element tasks that is consecutive, the task content identifying method including
acquiring sensor information indicating a state of the worker when the worker performs the element tasks,
storing each of determination models for each of the element tasks, for identifying each of the element tasks,
identifying the element task that the worker is performing, by comparing the sensor information of the worker that is acquired with the determination models for each of the element tasks that is stored, and
setting a priority of the determination model for each of the element tasks for when performing the comparison.

An aspect of the present disclosure for achieving the above object is
a storage medium storing a program for identifying a task content performed by a worker in a series of tasks made up of a plurality of element tasks that is consecutive, the program causing a computer to execute:
acquiring sensor information indicating a state of the worker when the worker performs the element tasks;
identifying the element task that the worker is performing, by comparing the sensor information of the worker that is acquired with determination models for identifying each of the element tasks; and
setting a priority of the determination model for each of the element tasks for when performing the comparison.

A primary object of the present disclosure is to provide a task content identifying system, a task content identifying method, and a storage medium, that can efficiently identify task content of a worker.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block-diagram showing a schematic system configuration of a task content identifying system according to the present embodiment; and

FIG. 2 is a flowchart illustrating a flow of a task content identifying method according to the present embodiment.

### DETAILED DESCRIPTION OF EMBODIMENTS

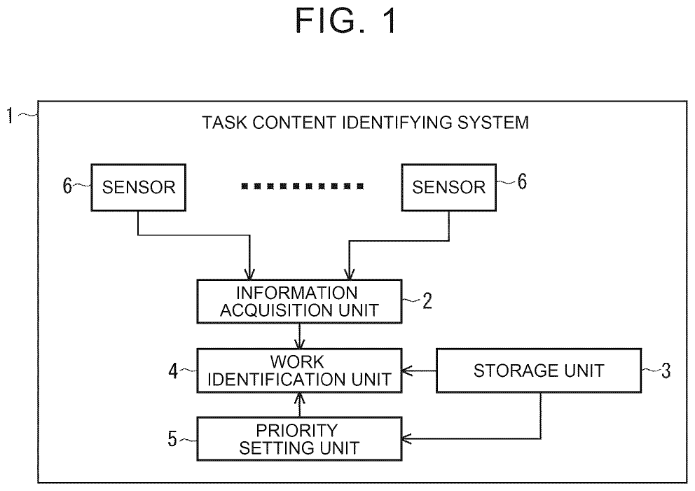

Hereinafter, the present embodiment will be described with reference to the drawings. FIG. 1 is a block diagram illustrating a schematic system configuration of a task content identifying system according to the present embodiment. The task content identifying system 1 according to the present embodiment is an apparatus for identifying the task content performed by a worker in a series of tasks including a plurality of consecutive element tasks. The element task includes, for example, a take-out task for taking out a part or the like, a tightening task for tightening a bolt, a nut, or the like, a fitting task for fitting a part or the like, a fitting task for fitting a part or the like, and the like. The worker is, for example, a worker who performs task on a manufacturing line.

For example, when a series of tasks of n cycles in the past is observed and the series of tasks of n cycles is the same task, the series of tasks is assumed to be a standard task. Then, the task content identifying system 1 may identify the task content performed by the worker in the standard work.

The task content identifying system 1 according to the present embodiment includes an information acquisition unit 2, a storage unit 3, a task identifying unit 4, and a priority setting unit 5.

The task content identifying system 1 has a hardware configuration of an ordinary computer including, for example, a processor such as CPU (Central Processing Unit) or GPU (Graphics Processing Unit), an internal memory such as RAM (Random Access Memory) or ROM (Read Only Memory), a storage device such as HDD (Hard Disk Drive) or SSD (Solid State Drive), an input/output I/F for connecting a peripheral device such as a display, and a communication I/F for communicating with an external device.

The information acquisition unit 2 is a specific example of an information acquisition unit. The information acquisition unit 2 acquires sensor information indicating a state of the worker when the worker performs the element task. The information acquisition unit 2 acquires, for example, sensor information in the element task a of the time t−1, sensor information in the element task b of the time t, sensor information in the element task c of the time t+1.

The information acquisition unit 2 acquires sensor information from, for example, a sensor 6 attached directly to a worker or indirectly via a wearable device or the like, or a sensor 6 attached to a task environment. The information acquisition unit 2 acquires sensor information via a wire such as a wire or wirelessly such as Bluetooth (registered trademark) or Wifi (registered trademark).

The sensor 6 includes, for example, a camera, a microphone, an acceleration sensor, a biological sensor, a temperature sensor, a pressure sensor, and the like. The sensor information includes, for example, a still image or a moving image of the worker, a sound of the worker, an environmental sound, and the like.

The storage unit 3 is a specific example of a storage unit. The storage unit 3 stores a determination model of each element task for identifying each element task. The determination model is information obtained by modeling actual sensor information when a worker performs element task. The storage unit 3 includes the storage device and the like.

The task identifying unit 4 is a specific example of a task identifying unit. The task identifying unit 4 specifies the element task performed by the worker by comparing the sensor information of the worker acquired by the information acquisition unit 2 with the determination model of each element task stored by the storage unit 3.

For example, it is assumed that after the worker performs the element task in the time t−1, the worker performs the following element task at the time t. The task identifying unit 4 specifies the element task at the time t. For example, the task identifying unit 4 specifies the element task performed by the worker by using a pattern matching process or the like on the basis of the image information of the worker acquired by the information acquisition unit 2 and the image information of the determination model of each element task stored by the storage unit 3.

More specifically, the task identifying unit 4 calculates the similarity between the image information of the worker acquired by the information acquisition unit 2 and the image information of the determination model of each element task. The task identifying unit 4 specifies the element task corresponding to the image information of the determination model in which the calculated similarity is equal to or greater than the predetermined value as the task content performed by the worker.

Here, for example, it is assumed that a certain task is a fitting task, and sensor information of a certain task is compared with each other in the order of a model for determination of an extraction task, a model for determination of a tightening task, a model for determination of a fitting task, and a model for determination of a fitting task. In this case, it is at the time of the fourth comparison that a certain task is found to be a fitting task, and the previous three comparisons are a waste of calculation. As described above, when the sensor information of the worker and the determination model of each task are compared in random order, the calculation is wasted and the efficiency is low.

On the other hand, in the present embodiment, the priority setting unit 5 sets the priority of the determination model of each element task when the task identifying unit 4 performs the comparison. Thus, for example, by setting the priority of the determination model of each element task so as to suppress the waste of the calculation, the waste of the calculation can be suppressed, and the task content of the worker can be identified efficiently.

The priority setting unit 5 is a specific example of a priority setting unit. The task identifying unit 4 compares the sensor information of the worker acquired by the information acquisition unit 2 in order from the determination model of the element task having the high priority set by the priority setting unit 5. Then, when the compared element task determination model matches the sensor information of the worker, the task identifying unit 4 specifies the element task of the matched determination model as the task content performed by the worker.

For example, in the series of tasks, the probability values of the respective element tasks performed next to the respective element tasks may be set in advance as the probability table information. Specifically, the task performed next to the take-out task is set as a probability 50% of the tightening work, a probability 25% of the fitting work, a probability 25% of the fitting work, and the like. In this way, the probability of the next element task is set for each element task. The probability of each element task may be set based on the accumulated task data. Further, by including, in the task data, for example, process information of the task and information such as a tool used for the work, the probability of each element task can be set with higher accuracy.

The priority setting unit 5 sets the priority of the determination model of the element task having a high probability value to be high based on the probability table. As a result, the task identifying unit 4 can compare the sensor information of the worker acquired by the information acquisition unit 2 in order from the determination model of the element task having a high priority set by the priority setting unit 5 and having a high probability of being performed next. Therefore, it is possible to suppress the above-mentioned useless comparison, and to identify the task content of the worker efficiently, at high speed, and with high accuracy.

Note that, for example, the task identifying unit 4 may compare only the first determination, the sensor information of the worker acquired by the information acquisition unit 2, and the determination model selected at random, and identify the task content of the worker. After that, at a stage where several cycles of task are performed and the task information is accumulated, as described above, the task identifying unit 4 compares the sensor information of the worker acquired by the information acquisition unit 2 in order from the determination model of the element task having the high priority set by the priority setting unit 5, and specifies the task content of the worker.

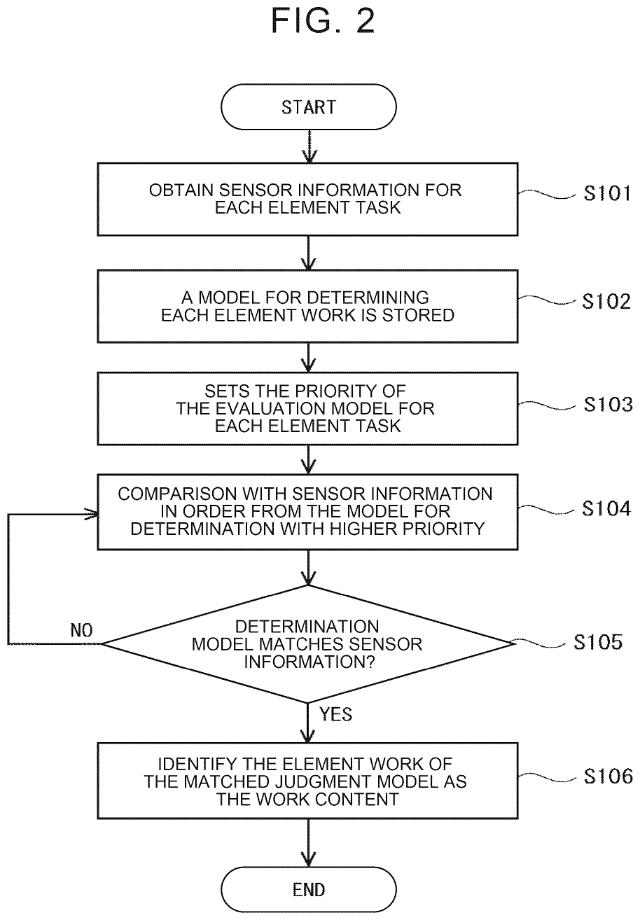

Next, the task content identifying method according to the present embodiment will be described in detail. FIG. 2 is a flowchart illustrating a flow of a task content identifying method according to the present embodiment.

The information acquisition unit 2 acquires sensor information when a worker performs respective element tasks (S101).

The storage unit 3 stores the determination models of the respective element tasks (S102). The priority setting unit 5 sets priorities of the determination models of the respective element tasks on the basis of the probability table (S103). Note that (S102) and (S103) may be executed prior to (S101).

The task identifying unit 4 compares the sensor information of the worker acquired by the information acquisition unit 2 with the determination model of the higher-priority element task set by the priority setting unit 5 in order (S104).

When the determination model of the element task matches the sensor information of the worker (YES of S105), the task identifying unit 4 specifies the element task of the matched determination model as the task content performed by the worker (S106). On the other hand, when the determination model of the element task and the sensor data of the worker do not coincide with each other (NO of S105), the task identifying unit 4 performs the above-described process (S104).

As described above, the task content identifying system 1 according to the present embodiment includes the information acquisition unit 2 that acquires the sensor information when the worker performs each element task, the storage unit 3 that stores the determination model of each element task, the sensor information of the worker acquired by the information acquisition unit 2, and the determination model of each element task stored by the storage unit 3, respectively, and the task identifying unit 4 that specifies the element task performed by the worker, and the priority setting unit 5 that sets the priority of the determination model of each element task when the task identifying unit 4 performs the comparison. Accordingly, it is possible to efficiently identify the task content of the worker.

While certain embodiments have been described, these embodiments have been presented by way of example only, and are not intended to limit the scope of the disclosure. These new embodiments can be performed in other various forms, and various kinds of removals, replacements and modifications are possible without departing from the meaning of the present disclosure. These embodiments and their modifications are intended to be embraced in the range and meaning of the present disclosure, and are particularly intended to be embraced in the disclosure disclosed in the range of the claims and the equivalency thereof.

For example, the present disclosure can be realized by causing a processor to execute a computer program in the processing illustrated in FIG. 2. The program is stored in a storage medium.

The program may be stored and provided to the computer using various types of non-transitory computer readable media (non-transitory computer readable medium). Non-transitory computer-readable media include various types of tangible storage media (tangible storage medium). Exemplary non-transitory computer-readable media include magnetic recording media (e.g., flexible disks, magnetic tapes, hard disk drives), magneto-optical recording media (e.g., magneto-optical disks), CD-ROM (Read Only Memory), CD-R, CD-R/W, solid-state memories (e.g., masking ROM, PROM (Programmable ROM), EPROM (Erasable PROM), flash ROM, RAM (random access memory)).

The program may be provided to the computer by various types of transitory computer readable media (transitory computer readable medium). Examples of the transitory computer-readable media include electrical signals, optical signals, and electromagnetic waves. The transitory computer-readable media can supply the program to the computer via a wired communication path such as an electric wire and an optical fiber, or a wireless communication path.

Each unit of the task content identifying system 1 according to the above-described embodiments can be realized not only by a program but also by dedicated hardware such as an ASIC (Application Specific Integrated Circuit) or an FPGA (Field-Programmable Gate Array).

What is claimed is:

1. A task content identifying system for identifying a task content performed by a worker in a series of tasks made up of a plurality of element tasks that is consecutive, the task content identifying system comprising:
an information acquisition unit that acquires sensor information indicating a state of the worker when the worker performs the element tasks;
a storage unit that stores each of determination models for each of the element tasks, for identifying each of the element tasks;
a task identifying unit that identifies the element task that the worker is performing, by comparing the sensor information of the worker acquired by the information acquisition unit with the determination models for each of the element tasks stored in the storage unit; and
a priority setting unit that sets a priority of the determination model for each of the element tasks for when the task identifying unit performs the comparison.

2. The task content identifying system according to claim 1, wherein the task identifying unit compares the sensor information of the worker acquired by the information acquisition unit with the sensor information of the worker, in order from the determination model of the element task to which a high priority is set by the priority setting unit, and when the determination model of the element task matches the sensor information of the worker, identifies the element task of the determination model that matched as being the task content being performed by the worker.

3. The task content identifying system according to claim 2, wherein:
in the series of tasks, a probability value of each of the element tasks to be performed subsequent to each of the element tasks is set in advance; and
the priority setting unit sets the priority of the determination model of the element task of which the probability value is high, to be high.

4. A task content identifying method of identifying a task content performed by a worker in a series of tasks made up of a plurality of element tasks that is consecutive, the task content identifying method comprising:
acquiring sensor information indicating a state of the worker when the worker performs the element tasks;
storing each of determination models for each of the element tasks, for identifying each of the element tasks;
identifying the element task that the worker is performing, by comparing the sensor information of the worker that is acquired with the determination models for each of the element tasks that is stored; and
setting a priority of the determination model for each of the element tasks for when performing the comparison.

5. A non-transitory storage medium storing a program for identifying a task content performed by a worker in a series of tasks made up of a plurality of element tasks that is consecutive, the program causing a computer to execute:
acquiring sensor information indicating a state of the worker when the worker performs the element tasks;
identifying the element task that the worker is performing, by comparing the sensor information of the worker that is acquired with determination models for identifying each of the element tasks; and
setting a priority of the determination model for each of the element tasks for when performing the comparison.
